(19) United States
(12) Patent Application Publication
(10) Pub. No.: US 2011/0187879 A1
(43) Pub. Date: Aug. 4, 2011

(54) IMAGING DEVICE AND IMAGE PROCESSING PROGRAM

(75) Inventor: Toru Ochiai, Kashiwa-shi (JP)

(73) Assignee: NIKON CORPORATION, TOKYO (JP)

(21) Appl. No.: 12/674,616

(22) PCT Filed: Aug. 15, 2008
(86) PCT No.: PCT/JP2008/002218

§ 371 Date: Feb. 22, 2010

(30) Foreign Application Priority Data
Sep. 10, 2007 (JP) 2007-234558

(51) Int. Cl. H04N 5/228

(52) U.S. Cl. 348/222.1; 348/E05.031

(57) ABSTRACT

The present application provides an imaging device and an image processing program capable of recording an image suitable for image editing. The imaging device includes an imaging section imaging a subject by an image sensor to generate data of a first image in a pixel range and data of a second image in a second pixel range circumscribing the first image, the first image having an angle of view desired by a user, and a recording section recording the data of the first image and records the data of the second image as additional information of the data of the first image.

### TECHNICAL FIELD

The present application relates to imaging devices and image processing programs.

### BACKGROUND ART

When a subject is imaged with an imaging device held by hands, a user often involuntarily images with the imaging device tilted. Therefore, in the application of Patent Document 1, when a video camera is tilted at the time of imaging, the image is corrected so as to be in a horizontal state by rotation processing.

Patent Document 1: Japanese Unexamined Patent Application Publication No. H06-178190

### DISCLOSURE OF THE INVENTION

### Problems to be Solved by the Invention

Incidentally; when an image is rotated, a triangular space occurs on all sides of the image after the rotation. In order to avoid such a problem, an advanced user, in preparation for the rotation processing, picks up an image having an angle of view wider than the angle of view of a desired image in advance. By picking up such an image, a processing of cutting out an area that does not include a blank space from the image after the rotation is possible. However, it is extremely difficult for beginners to pick up an image having a wide angle of view in advance. Moreover, when an image having a wide angle of view is picked up in advance, a difference may occur between a composition determined by a user at the time of imaging and the composition of the image after rotation processing, causing the user to feel uncomfortable with this difference.

Then, an imaging device and an image processing program of the present application are intended to record an image suitable for image editing.

### Means for Solving the Problems

An imaging device of the present embodiment includes an imaging section imaging a subject to generate data of a first image having an angle of view desired by a user and data of a second image circumscribing the first image, and a recording section recording the data of the first image and recording the data of the second image as additional information of the data of the first image.

Preferably, the imaging section may include an image sensor separately reading the data of the first image and the data of the second image.

Moreover, the imaging section may divide image data generated by imaging the subject and generate the data of the first image and the data of the second image.

Further preferably, the imaging device may further include a rotation angle detecting section detecting a rotation angle relative to a horizontal state of the imaging device, and an angle determining section determining whether the imaging device is in the horizontal state or not based on the rotation angle detected by the rotation angle detecting section, in which the recording section may record the data of the second image only when the imaging device is not in the horizontal state.

Further preferably, the imaging device may further include an image processing section reading the data of the first image and the data of the second image from the recording section and generating a third image by combining the first image and the second image, a displaying section displaying the first image, and an operating section receiving an instruction of a rotation of the first image from the user, in which the image processing section may rotate the third image according to the instruction of the rotation and cut out, from the third image after the rotation, an image corresponding to a size of the first image.

Further preferably, the imaging device may further include an image processing section reading the data of the first image and the data of the second image from the recording section and generating a third image by combining the first image and the second image, a displaying section displaying the first image, and an operating section receiving an instruction to shift the angle of view of the first image from the user, in which the image processing section may shift the angle of view of the first image according to the instruction and cut out, from the third image, an image corresponding to the angle of view of the first image after the shift, or may shift the third image according to the instruction and cut out, from the third image after the shift, an image corresponding to same position and same size as the first image.

Further preferably, the imaging device may further include an image processing section reading the data of the first image and the data of the second image from the recording section and generating a third image by combining the first image and the second image, a displaying section displaying the first image, and an operating section receiving a magnification for zooming out the first image from the user, in which the image processing section may reduce the third image according to the magnification and cut out, from the third image being reduced, an image corresponding to a size of the first image, or may expand the angle of view of the first image according to the magnification, cut out, from the third image, an image corresponding to the angle of view of the first image being expanded, and reduce the image being cut out to the size of the first image.

Further preferably, the image sensor may change a pixel area corresponding to the first image.

Further preferably, the imaging section may be capable of changing a size of the first image by changing an area where the image data is to be divided.

In addition, representations obtained by converting the configurations of the above-described embodiment into an image processing program for realizing an image processing on the data of an image to be processed are also effective as a specific aspect of the present application.

### Effects of the Invention

The imaging device and the image processing program of the present application can record an image suitable for image editing.

### BRIEF DESCRIPTION OF THE DRAWINGS

FIG. 1 is a block diagram showing a configuration of an imaging device 1 of a first embodiment.

FIG. 2 is a view showing an operation of an imaging device controlling section 8 at the time of imaging in the imaging device 1 of the first embodiment.

FIG. 3 is a schematic diagram of an image sensor 3.

FIG. 4 is a view showing an example of an image file.

FIG. 5 is a view showing an operation of a computer control section 21 at the time of image editing in the imaging device 1.

FIG. 6 are views showing an example of an image in rotation processing.

FIG. 7 is a view showing an operation of the computer control section 21 at the time of shift processing in the imaging device 1.

FIG. 8 are views showing an example of an image at the time of the shift processing.

FIG. 9 is a view showing an operation of the computer control section 21 at the time of zoom-out processing in the imaging device 12.

FIG. 10 are views showing an example of an image at the time of the zoom-out processing.

FIG. 11 is a view showing an operation of the computer control section 21 at the time of zoom-in processing in the imaging device 1.

FIG. 12 are views showing an example of an image at the time of the zoom-in processing.

FIG. 13 is a view showing an operation of the imaging device controlling section 8 at the time of imaging in the imaging device 1 of a second embodiment.

FIG. 14 is a block diagram showing a configuration of a computer 21 of a third embodiment.

### BEST MODE FOR CARRYING OUT THE INVENTION

### First Embodiment

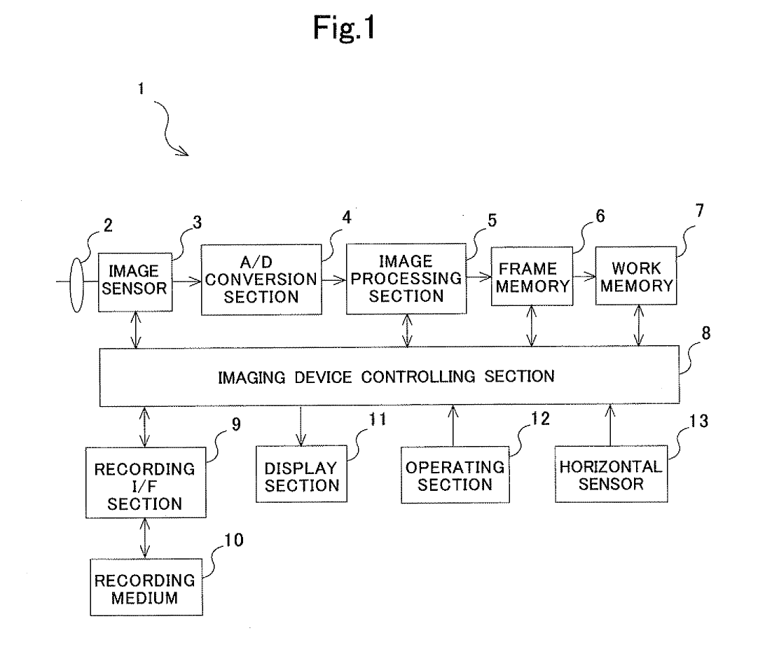

Hereinafter, a first embodiment of the present invention will be described using the accompanying drawings. FIG. 1 is a block diagram showing a configuration of an imaging device 1 in the first embodiment of the present invention. As shown in FIG. 1, the imaging device 1 includes an imaging lens 2, an image sensor 3, an A/D conversion section 4, an image processing section 5, a frame memory 6, a work memory 7, an imaging device controlling section 8, a recording I/F section 9, a recording medium 10, a display section 11, an operating section 12, and a horizontal sensor 13.

The imaging lens 2 forms a subject image on an imaging surface of the image sensor 3. The image sensor 3 photoelectrically converts the subject image due to a light beam passing through the imaging lens 2, and outputs an analog image signal. In addition, the image sensor 3 is a CMOS (Complementary Metal Oxide Semiconductor) image sensor and reads an image signal for each predefined pixel range under control of the imaging device controlling section 8. The output of the image sensor 3 is coupled to the A/D conversion section 4. The A/D conversion section 4 performs A/D conversion of the output signal of the image sensor 3. The image processing section 5 performs various kinds of image processing (color interpolation, tone conversion processing, contour enhancement processing, white balance adjustment, and the like) on the data output from the A/D conversion section 4. Moreover, the image processing section 5 executes a processing of compressing image data in the JPEG format or the like before recording the image data on the recording medium 10 and also a processing of decompressing the compressed data described above. Furthermore, the image processing section 5 executes image editing (rotation, shift, zoom-out, and zoom-in) by a known affine transformation or the like. The image processing section 5 can also cut out a part of an image area. The frame memory 6 temporarily records image data in the step prior to or subsequent to the image processing performed by the image processing section 5. The work memory 7 is used as a temporary memory for example when the image processing section 5 performs various kinds of image processing. The imaging device controlling section 8 is a processor that performs an integral control of an electronic camera according to a predetermined sequence program.

In the recording I/F section 9, a connector for connecting the recording medium 10 is formed. Then, the recording I/F section 9 performs a data write/read operation on the recording medium 10 coupled to the connector. The display section 11 displays various kinds of images under control of the imaging device controlling section 8. Moreover, on the display section 11, a menu screen allowing input in the GUI (Graphical User Interface) format can be displayed under control of the imaging device controlling section 8. The operating section 12 includes a release button, an operating button, and the like. The release button of the operating section 12 receives an instruction of imaging operation from a user. The operating button of the operating section 12 receives an input in the above-described menu screen or the like from a user. The horizontal sensor 13 detects a rotation angle of the imaging device 1 and outputs the same to the image processing section 5.

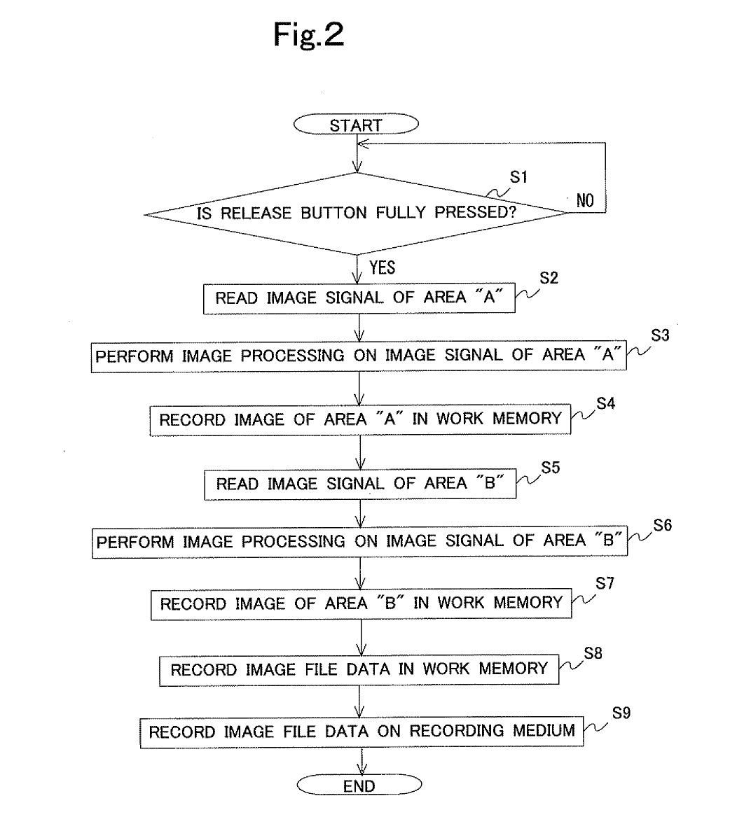

FIG. 2 is a flowchart showing an operation of the imaging device controlling section 8 at the time of imaging in the imaging device 1.

In Step S1, the imaging device controlling section 8 determines whether or not the release button is fully pressed. If the release button is fully pressed (YES), the flow moves to S2. On the other hand, if the release button is not fully pressed yet (NO), the imaging device controlling section 8 waits until the release button is fully pressed.

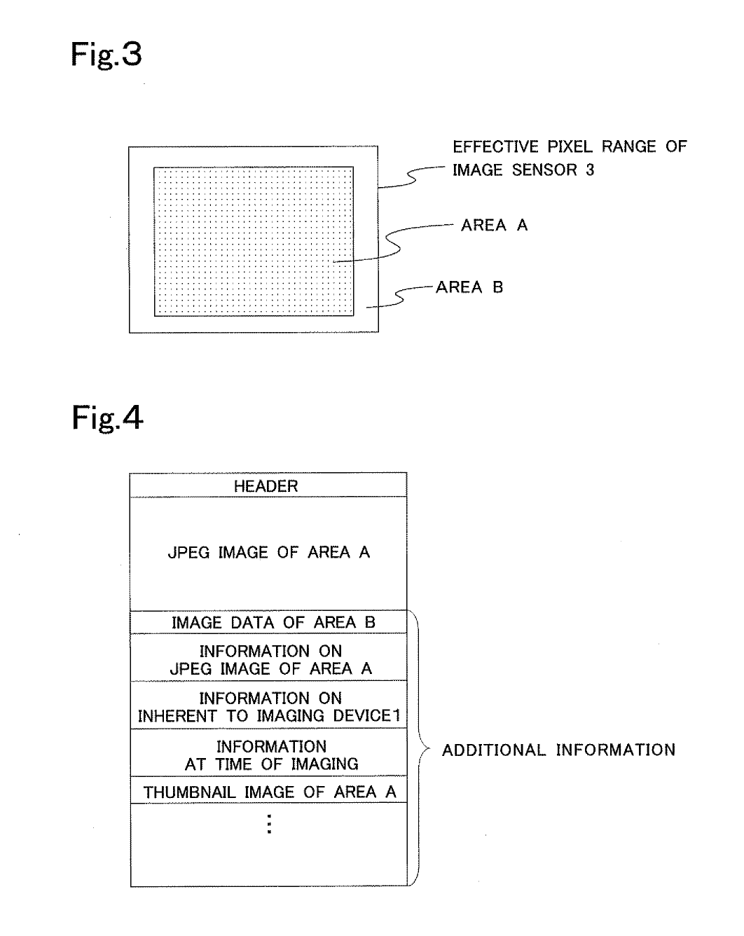

In Step S2, the imaging device controlling section 8 drives the image sensor 3 to read an image signal of an area A. Here, the pixel range of the image sensor 3 is described. FIG. 3 is a schematic diagram of the image sensor 3. As shown in FIG. 3, in an effective pixel range of the image sensor 3, a pixel area corresponding to an image having an angle of view desired by a user is referred to as an area A while a pixel area circumscribing the area A is referred to as an area B. For example, assume a total number of effective pixels is approximately 12 million pixels (4000×3000 pixels) and the area A includes approximately 10 million pixels (3648×2736 pixels). Note that, since the image sensor 3 is a CMOS image sensor as described above, it can separately read an image signal of the area A and an image signal of the area B. The imaging device controlling section 8 reads the image signal of the area A, and the flow moves to Step S3.

In Step S3, the imaging device controlling section 8 controls the image processing section 5 to perform various kinds of image processing on the image data of the area A output from the A/D conversion section 4 and compress the image data of the area A in the J PEG format.

In Step S4, the imaging device controlling section 8 records the image data of the area A in the frame memory 6 and then records the same in the work memory 7.

In Step S5, the imaging device controlling section 8 drives the image sensor 3 to read the image signal of the area B described in Step S2.

In Step S6, the imaging device controlling section 8 controls the image processing section 5 to perform various kinds of image processing on the image data of the area B output from the A/D conversion section 4. Note that the image data of the area B is assumed to be uncompressed data.

In Step S7, the imaging device controlling section 8 records the image data of the area B in the frame memory 6 and then record the same in the work memory 7.

In Step S8, the imaging device controlling section 8 prepares an image file shown in FIG. 4 and records the same in the work memory 7.

FIG. 4 is a view showing the content of the image file. As shown in FIG. 4, the image file includes a JPEG image of the area A and additional information. The additional information includes image data of the area 13, information on the JPEG image of the area A (the size of the area A, gradation and the like), information inherent to the imaging device 1 (the model name of the imaging device 1, the type name of the imaging lens 2, and the like), information at the time of imaging (the rotation angle of the imaging device 1 based on the horizontal sensor 13, aperture value, sensitivity, and the like), a thumbnail image of the area A, and the like. That is, the image data of the area B is recorded together with various kinds of information into the image file as the additional information on the image of the area A. For this reason, a user is not aware of the fact that the image data of the area B is recorded in the image file except at the time of image editing described later. That is, a user can usually handle the image file as the image file of the area A, as with the conventional image file.

In Step S9, the imaging device controlling section 8 records an image file, which is recorded in the work memory 7 in Step S8, on the recording medium 10 via the recording I/F section 9.

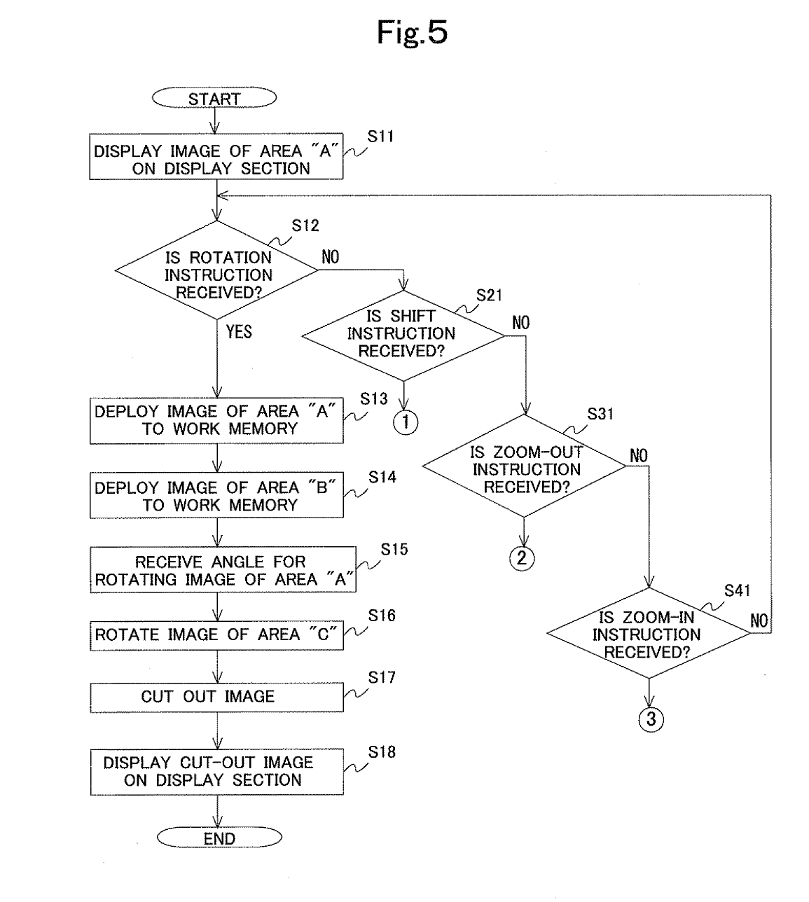

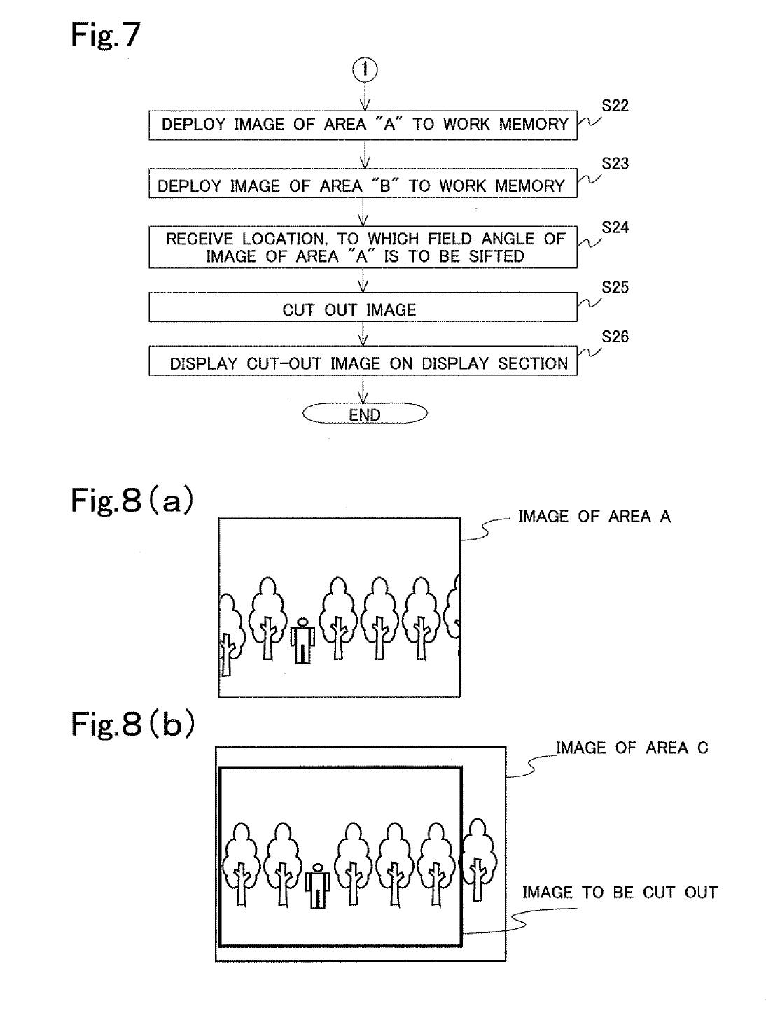

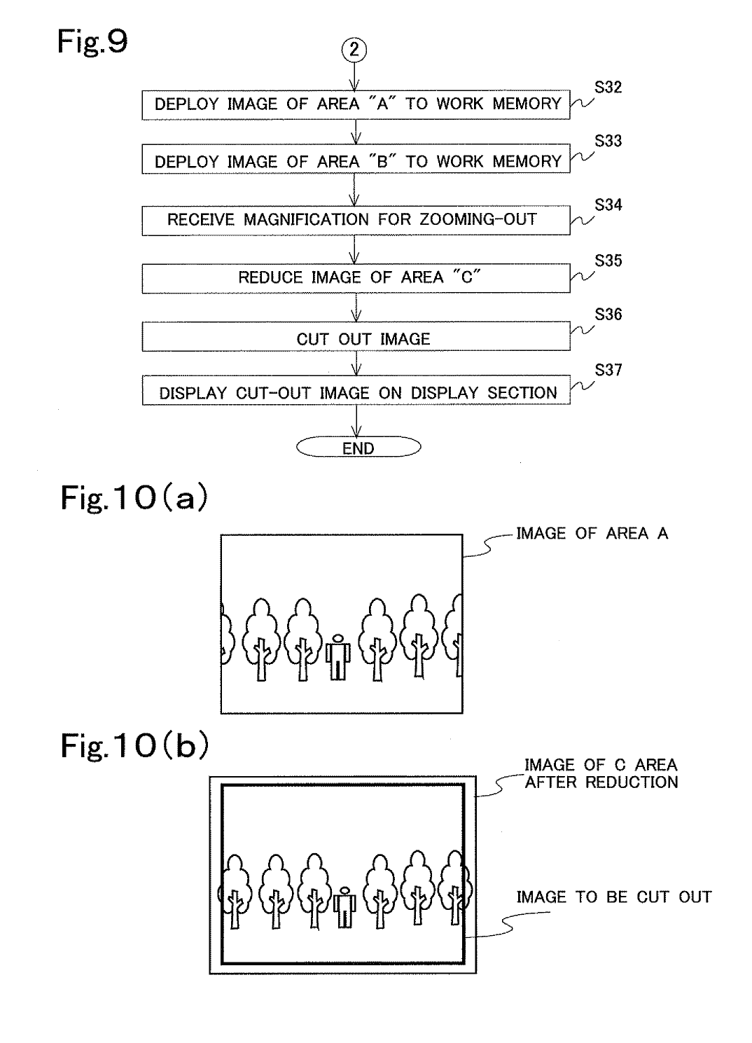

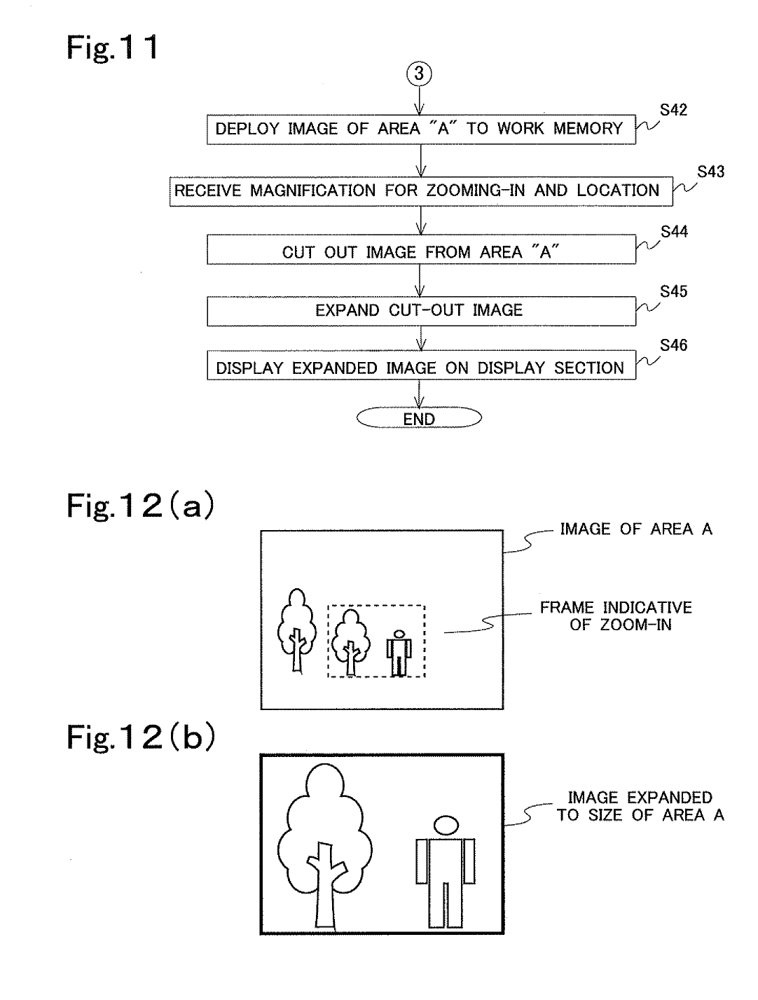

Next, the image editing processing will be described. FIGS. 5, 7, 9, and 11 are flowcharts showing the operations of the imaging device controlling section 8 at the time of image editing in the imaging device 1. Note that, the imaging device controlling section 8 is described on the assumption that the imaging device controlling section 8 receives the specification of an image, which is subjected to image editing, from a user via the operating section 12 in advance.

In Step S11, the imaging device controlling section 8 displays the image of the area A on the display section 11.

In Step S12, the imaging device controlling section 8 determines whether or not an instruction to rotate the image of the area A is received from a user via the operating section 12. If the rotation instruction is received (YES), the flow moves to Step S13. On the other hand, if the rotation instruction is not received yet (NO), the flow moves to Step S21 to be described later.

In Step S13, the imaging device controlling section 8 deploys the image of the area A to the work memory 7.

In Step S14, the imaging device controlling section 8 deploys the image of the area to the work memory 7. The imaging device controlling section 8 generates an image corresponding to the effective pixel range of the image sensor 3 by combining the image of the area A deployed in Step S13 and the image of the area B. This image is referred to as an image of a C area. Note that, when deploying the image of the area B, the imaging device controlling section 8 may also perform a processing of converting the resolution of the image data of the area B so as to match the resolution of the image of the area A.

In Step S15, the imaging device controlling section 8 receives a rotation angle of the image of the area A from a user via the operating section 12. For example, the imaging device controlling section 8 receives a numerical value of the rotation angle from a user. Moreover, the imaging device controlling section 8 may display a menu screen or an icon indicative of the rotation on the display section 11 to thereby receive the rotation angle from a user.

In Step S16, the imaging device controlling section 8 controls the image processing section 5 to rotate the image of the C area based on the rotation angle received in Step S15.

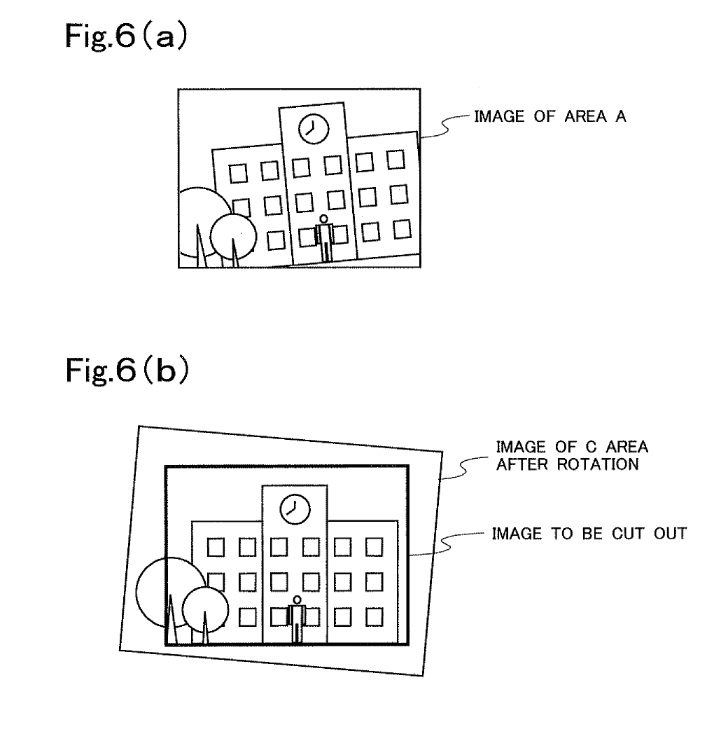

In Step S17, the imaging device controlling section 8 controls the image processing section 5 to cut out an image corresponding to the size of the area A from the image of the C area after the rotation. An example of the image of the area A is shown in FIG. 6(a), and an example of an image to be cut out from the image of the C area after the rotation is shown in FIG. 6(b).

In Step S18, the imaging device controlling section 8 displays the image, which is cut out in Step S17, on the display section 11.

If the rotation instruction is not received yet (NO) in Step S12, then in Step S21 the imaging device controlling section 8 determines whether or not a shift instruction is received from a user via the operating section 12. If the shift instruction is received (YES), the flow moves to Step S22. On the other hand, if the shift instruction is not received yet (NO), the flow moves to Step S31 to be described later.

Since Steps S22 to S23 respectively correspond to Steps S13 to S14 of FIG. 5, the duplicated description thereof is omitted.

In Step S24, the imaging device controlling section 8 receives a location, to which an angle of view of the image of the area A is shifted, from a user via the operating section 12. For example, the imaging device controlling section 8 receives from a user a numerical value indicative of the coordinate of the image after shifting. Moreover, the imaging device controlling section 8 may display a menu screen or a frame indicative of the shift on the display section 11 to thereby receive a displacement of the angle of view of the image of the area A from a user.

In Step S25, the imaging device controlling section 8 controls the image processing section 5 to cut out from the image of the C area an image corresponding to the angle of view of the image of the area A after the shift. An example of the image of the area A is shown in FIG. 8(a), and an example of the image cut out from the image of the C area is shown in FIG. 8(b).

In Step S26, the imaging device controlling section 8 displays the image, which is cut out in Step S25, on the display section 11.

If the shift instruction is not received yet (NO) in Step S21, then in Step S31 the imaging device controlling section 8 determines whether or not a zoom-out instruction is received from a user via the operating section 12. If the zoom-out instruction is received (YES), the flow moves to Step S32. On the other hand, if the zoom-out instruction is not received yet (NO), the flow moves to Step S41 to be described later.

Since Steps S32 to 533 respectively correspond to Steps S13 to S14 of FIG. 5, the duplicated description thereof is omitted.

In Step S34, the imaging device controlling section 8 receives a magnification for zooming out the image of the area A from a user via the operating section 12. For example, the imaging device controlling section 8 receives a numerical value of the magnification for zoom-out from a user. Moreover, the imaging device controlling section 8 may display a menu screen or a frame indicative of the zoom-out on the display section 11 to thereby receive a reduction of the angle of view of the image of the area A from a user.

In Step S35, the imaging device controlling section 8 controls the image processing section 5 to reduce the image of the C area based on the magnification received in Step S34.

In Step S36, the imaging device controlling section 8 controls the image processing section 5 to cut out an image corresponding to the size of the area A from the image of the C area after the reduction. An example of the image of the area A is shown in FIG. 10 (a), and an example of the image cut out from the image of the C area after the reduction is shown in FIG. 10 (b).

In Step S37, the imaging device controlling section 8 displays the image, which is cut out in Step S36, on the display section 11.

If the zoom-out instruction is not received yet (NO) in Step S31, then in Step S41 the imaging device controlling section 8 determines whether or not a zoom-in instruction is received from a user via the operating section 12. If the zoom-in instruction is received (YES), the flow moves to Step S42. On the other hand, if the zoom-out instruction is not received yet (NO), the flow returns to Step S12.

Since Step S42 corresponds to Step S13 of FIG. 5, the duplicated description thereof is omitted.

In Step S43, the imaging device controlling section 8 receives a magnification for zooming in the image of the area A and its location from a user via the operating section 12. For example, the imaging device controlling section 8 receives a numerical value of the magnification for the zoom-in from a user. Moreover, the imaging device controlling section 8 may display a menu screen or a frame indicative of the zoom-in on the display section 11 to thereby receive a reduction of the angle of view of the image of the area A from a user.

In Step S44, the imaging device controlling section 8 controls the image processing section 5 to reduce the angle of view of the image of the A area based on the magnification and the location received in Step S34.

In Step S45, the imaging device controlling section 8 controls the image processing section 5 to cut out an image corresponding to the angle of view of the area A reduced from the image of the area A and then expand the cut-out image to the size of the area A. An example of the image of the area A is shown in FIG. 12 (a), and an example of the image expanded to the size of the area A is shown in FIG. 12 (b).

In Step S46, the imaging device controlling section 8 displays the image, which is expanded in Step S45, on the display section 11.

Hereinafter, the functions and effects of the first embodiment will be described. Since the imaging device 1 of the first embodiment records an image of the angle of view wider than an image of the angle of view desired by a user, it can record an image suitable for image editing.

Moreover, according to the imaging device 1 of the first embodiment, since an image data outside the angle of view desired by a user is recorded as additional information, a user is usually not aware of the fact that the image data outside the desired angle of view is recorded in the image file. Accordingly, a user can usually handle the image file as the image file of the desired angle of view, as with the conventional image file.

### Second Embodiment

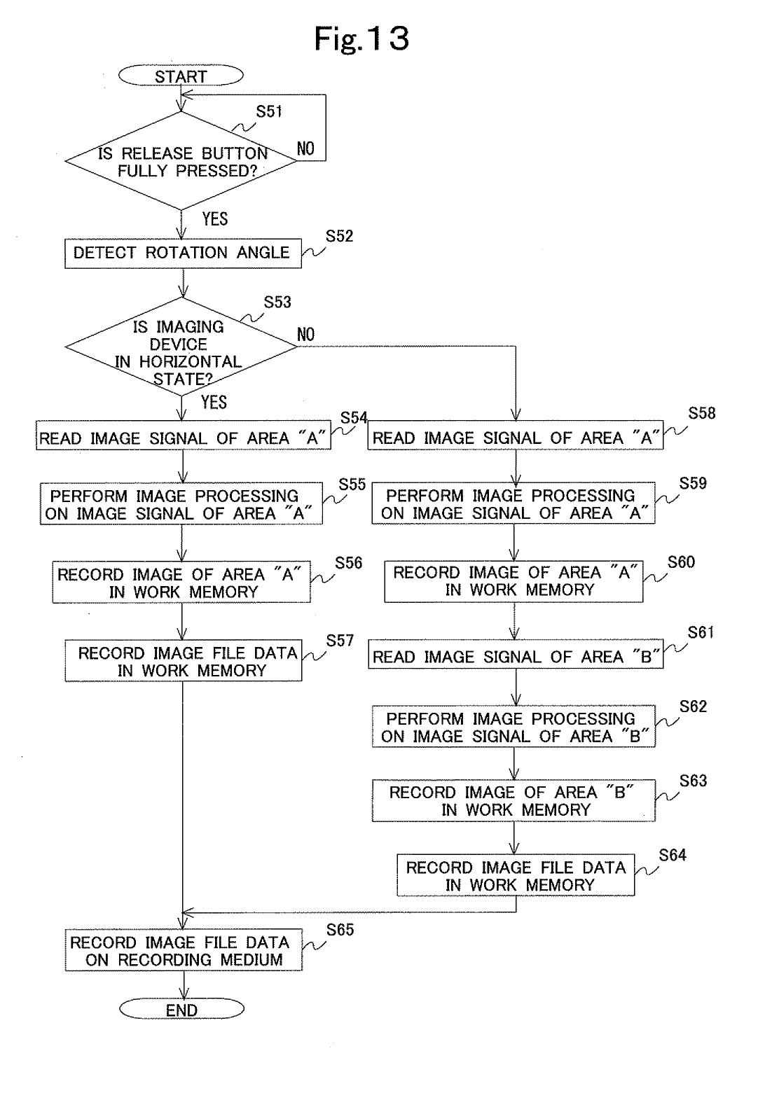

Hereinafter, a second embodiment of the present invention is described. Here, since the configuration of an imaging device in the following embodiment is common to that of the imaging device 1 of the first embodiment shown in FIG. 1, the duplicated description thereof is omitted. FIG. 13 is a flowchart showing an operation of the imaging device controlling section 8 at the time of imaging in the imaging device 1 of the second embodiment.

In Step S51, the imaging device controlling section 8 determines whether or not the release button is fully pressed, as in Step S1 of FIG. 2. If the release button is fully pressed (YES), the flow moves to S52. On the other hand, when the release button is not fully pressed yet (NO), the imaging device controlling section 8 waits until the release button is fully pressed.

In Step S52, the imaging device controlling section 8 controls the horizontal sensor 13 to detect the rotation angle of the imaging device 1 and output the same to the image processing section 5.

In Step S53, the imaging device controlling section 8 determines whether or not the rotation angle detected in Step S52 is in a horizontal state. If it is in the horizontal state (YES), the flow moves to Step S54. On the other hand, if it is not in the horizontal state (NO), the flow moves to Step S57.

Since, Step S54 to Step S56 respectively correspond to Step S2 to Step S4 of FIG. 2, the duplicated description thereof is omitted.

In Step S57, the imaging device controlling section 8 prepares the image file of the area A and records the same in the work memory 7. Note that the image file of the area A is assumed to be an image file similar to the image file shown in FIG. 4 excluding the image data of the area B.

Since Step S58 to Step S65 respectively correspond to Step S2 to Step S9 of FIG. 2, the duplicated description thereof is omitted.

Note that, the imaging device 1 of the second embodiment can perform rotation processing on the image file generated through the above-described flow, as with the imaging device 1 of the first embodiment.

Hereinafter, the functions and effects of the second embodiment will be described. When the imaging device 1 of the second embodiment is determined not to be in a horizontal state, the imaging device 1 records an image having an angle of view wider than the angle of view desired by a user in preparation for the rotation processing of the image. Accordingly, the imaging device 1 of the second embodiment can record a suitable image for the rotation processing, as in the first embodiment.

Moreover, the imaging device 1 of the second embodiment records the image having an angle of view greater than the angle of view desired by a user, only when the imaging device 1 is determined not to be in a horizontal state, i.e., when it is determined that the imaging device 1 needs to prepare for the rotation processing of the image. Accordingly, when the imaging device 1 need not prepare for the rotation processing of the image, the image having an angle of view wider than the angle of view desired by a user is not recorded. For this reason, more image data can be recorded on the recording medium 10 without wasting the recording area of the recording medium 10.

Note that, in the first embodiment and the second embodiment, examples are shown, in which the imaging device 1 includes the horizontal sensor 13 and the rotation angle of the imaging device 1 is detected with the horizontal sensor 13, but the rotation angle of the imaging device 1 may be detected by conducting image analysis from the through-images.

### Third Embodiment

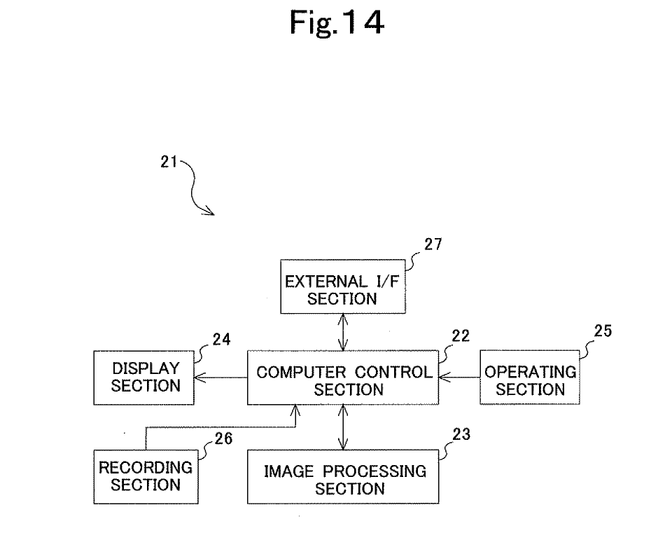

Hereinafter, a third embodiment of the present invention will be described. In the third embodiment of the present invention, the image editing of the image file generated in the first embodiment or the second embodiment is implemented by a computer. FIG. 14 is a block diagram showing a configuration of a computer 21 in the third embodiment of the present invention.

The computer 21 includes a computer control section 22, an image processing section 23, a display section 24, an operating section 25 including a keyboard, a mouse, and the like, a recording section 26, and an external I/F section 27 capable of connecting the imaging device 1 of the first embodiment or the second embodiment with each other. The computer 21 receives an instruction from a user via the operating section 25, and displays on the display section 24 an image obtained from the imaging device 1 of the first embodiment or the second embodiment, or an image recorded in the recording section 26. The image processing section 23 performs the same image processing (see the flowcharts of FIGS. 5, 7, 9, and 11) as that by the image processing section 5 of the imaging device 1 of the first embodiment or the second embodiment by an image processing program.

With the computer 21 of the third embodiment, the same processing as that of the first embodiment or the second embodiment can be performed and a suitable image editing processing can be performed.

(Supplement of the Embodiments)

Note that, in the rotation processing of the first embodiment, an example is shown, in which the image of the C area is rotated according to an instruction of the rotation angle from a user, but the rotation process flow is not limited to this. For example, in the example of FIG. 5, the imaging device controlling section 8 determines whether or not the imaging device 1 is in a horizontal state based on the rotation angle output by the horizontal sensor 13 in stead of the user instruction of Step S15. Then, the imaging device controlling section 8 may control the image processing section 5 to automatically rotate the image of the C area into a horizontal state when the imaging device 1 is determined not to be in the horizontal state. Moreover, also in the rotation processing of the third embodiment, the same configuration described above may be employed. Note that, in the third embodiment, in place of the rotation angle output by the horizontal sensor 13, the rotation angle of the imaging device 1 may be detected by conducting image analysis from the image.

Moreover, in the shift processing of the first embodiment, an example is shown, in which the angle of view of the image of the area A is shifted and an image corresponding to the angle of view of the image of the area A after the shift is cut out from the image of the C area. But, the shift process flow is not limited to this. For example, in Step S24, the imaging device controlling section 8 receives a location, to which the image of the C area is to be shifted, from a user via the operating section 12. Then, in Step S25, the imaging device controlling section 8 may control the image processing section 5 to cut out an image corresponding to the same location and same size of the area A from the image of the C area after the shift. The same configuration described above may be employed also in the shift processing of the third embodiment.

Moreover, in the zoom-out processing of the first embodiment, an example is shown, in which the image of the C area is reduced and an image corresponding to the size of the area A is cut out from the reduced image of the C area. But, the zoom-out process flow is not limited to this. For example, in Step S35, the imaging device controlling section 8 controls the image processing section 5 to expand the angle of view of the image of the area A based on the magnification received in Step S34. Then, a configuration may be employed such that in Step S36, the imaging device controlling section 8 controls the image processing section 5 to cut out from the image of the C area an image corresponding to the angle of view of the image of the area A after the expansion and then reduces the cut-out image to the size of the area A. The same configuration described above may be employed also in the zoom-out processing of the third embodiment.

Moreover, in the zoom-in processing of the first embodiment, an example is shown, in which the angle of view of the image of the area A is reduced and an image corresponding to the angle of view of the area A reduced from the image of the area A is cut out and then the cut-out image is expanded to the size of the area A. But, the zoom-in process flow is not limited to this. For example, in Step S44, the imaging device controlling section 8 controls the image processing section 5 to expand the image of the C area based on the magnification received in Step S43. Then, a configuration may be employed such that in Step S45, the imaging device controlling section 8 controls the image processing section 5 to cut out an image corresponding to the size of the area A from the image of the C area after the expansion based on the magnification received in Step S43. The same configuration described above may be employed also in the zoom-in processing of the third embodiment.

Moreover, in the first embodiment or the third embodiment, an example is shown, in which the rotation processing, the shift processing, the zoom-out processing, and the zoom-in processing are separately performed. But, the image editing process flow is not limited to this. For example, in the example of FIG. 5, the imaging device controlling section 8 receives a combination of any processing among the above-described image editing processing from a user, after Step S11. Then, the imaging device controlling section 8 may sequentially perform the image processing according to an instruction from a user.

Moreover, in the first embodiment and the second embodiment, the size of the area A is not limited. For example, a configuration may be employed such that prior to Step S1 of FIG. 2, the imaging device controlling section 8 receives the size of the area A from a user via the operating section of the imaging device 1.

Moreover, in the second embodiment, the site of the area A may be changed according to the imaging conditions. For example, when a beginner picks up an image, he/she is likely to pick up the image with the imaging device more tilted as compared with when an advanced user picks up the image or when the image is picked up by using a tripod or the like. For this reason, when a beginner picks up an image, the range of the area B may be set larger so that an image corresponding to the size of the area A can be cut out from the area C after rotation even if the rotation angle of the imaging device increases. That is, in the example of FIG. 13, the imaging device controlling section 8 may receive from a user, prior to Step S51, either of the facts that a beginner picks up an image, that an advanced user picks up the image, or that the image is picked up by using a tripod. Then, when a beginner picks up the image, the imaging device controlling section 8 may set the wider range of the area B.

Moreover, when a beginner picks up an image, an image at the time of imaging is more likely to be modified because the image is picked up while the composition thereof is not determined yet, as compared with when an advanced user picks up the image. For this reason, when a beginner picks up an image, the range of the area 13 may be set wider so that an image of the angle of view shifted from the area C or an image of the zoomed-out angle of view can be cut out. That is, in the example of FIG. 2, when the image sensor 3 of the imaging device 1 of the first embodiment is a CMOS image sensor, the imaging device controlling section 8 may receive from a user, prior to Step S1, either of the instructions that the image is picked up by a beginner or that the image is picked up by an advanced user.

Moreover, in the first embodiment and the second embodiment, the image sensor 3 is not limited to the CMOS image sensor. For example, the image sensor 3 may be a CCD (Charge Coupled Device) image sensor. In this case, in Step S2 to Step S6 of FIG. 2, the image processing section 5 of the imaging device 1 may divide the image data generated by imaging a subject and generate the image data corresponding to the image data of the area A and the image data of the area B.

Moreover, in the first embodiment and the second embodiment, an image picked up by the imaging device 1 is not limited to a still image. For example, the imaging device 1 may be configured to pick up a moving image.

Moreover, in the first embodiment and the second embodiment, if an image data of the area B is additional information of the image data of the area A, the content of the image file may have configurations other than those in the above-described embodiments.

Moreover, in the first embodiment and the second embodiment, the image data of the area B is assumed to be an uncompressed data, but the data format is not limited to this. For example, the image data of the area B may be compressed in the JPEG format. Moreover, the image data of the area A may be an uncompressed data.

1. An imaging device, comprising:
an imaging section imaging a subject by an image sensor to generate data of a first image in a first pixel range and data of a second image in a second pixel range circumscribing the first image, the first image having an angle of view desired by a user; and
a recording section recording the data of the first image and recording the data of the second image as additional information of the data of the first image.

2. The imaging device according to claim 1, wherein
the imaging section separately reading a signal of the first image and a signal of the second image from the image sensor, and generating the data of the first image based on the signal of the first image and the data of the second image based on the signal of the second image.

3. The imaging device according to claim 1, wherein the imaging section divides image data generated by imaging the subject and generates the data of the first image and the data of the second image.

4. The imaging device according to claim 1, further comprising:
a rotation angle detecting section detecting a rotation angle relative to a horizontal state of the imaging device; and
an angle determining section determining whether the imaging device is in the horizontal state or not based on the rotation angle detected by the rotation angle detecting section, wherein
the recording section records the data of the second image when the imaging device is not in the horizontal state.

5. The imaging device according to claim 1, further comprising:
an image processing section reading the data of the first image and the data of the second image from the recording section and generating a third image by combining the first image and the second image;
a displaying section displaying the first image; and
an operating section receiving an instruction of a rotation of the first image from the user, wherein
the image processing section rotates the third image according to the instruction of the rotation and cuts out, from the third image after the rotation, an image corresponding to a size of the first image.

6. The imaging device according to claim 1, further comprising:
an image processing section reading the data of the first image and the data of the second image from the recording section and generating a third image by combining the first image and the second image;
a displaying section displaying the first image; and
an operating section receiving an instruction to shift the angle of view of the first image from the user, wherein
the image processing section shifts the angle of view of the first image according to the instruction and cuts out, from the third image, an image corresponding to the angle of view of the first image after the shift, or shifts the third image according to the instruction and cuts out, from the third image after the shift, an image corresponding to same position and same size as the first image.

7. The imaging device according to claim 1, further comprising:
an image processing section reading the data of the first image and the data of the second image from the recording section and generating a third image by combining the first image and the second image;
a displaying section displaying the first image; and
an operating section receiving a magnification for zooming out the first image from the user, wherein
the image processing section reduces the third image according to the magnification and cuts out, from the third image being reduced, an image corresponding to a size of the first image, or expands the angle of view of the first image according to the magnification, cuts out, from the third image, an image corresponding to the angle of view of the first image being expanded, and reduces the image being cut out to the size of the first image.

8. The imaging device according to claim 2, wherein the image sensor is capable of changing the first pixel range.

9. The imaging device according to claim 3, wherein
the imaging section is capable of changing a size of the first image by changing an area where the image data is to be divided.

10. An image editing apparatus, comprising:
an image processing section generating a third image by combining data of a first image in a first pixel range and data of a second image in a second pixel range circumscribing the first image, the first image having an angle of view desired by a user and the data of the first image being generated by an imaging device having an image sensor which images a subject;
a display control section displaying the first image on a display section; and
an operating section receiving an instruction of a rotation of the first image displayed on the display section from a user, wherein
the image processing section rotates the third image according to the instruction of the rotation and cuts out, from the third image after the rotation, an image corresponding to a size of the first image.

11. An image editing apparatus, comprising:
an image processing section generating a third image by combining data of a first image in a first pixel range and data of a second image in a second pixel range circumscribing the first image, the first image having an angle of view desired by a user and the data of the first image being generated by an imaging device having an image sensor which images a subject;
a display control section displaying the first image on a display section; and
an operating section receiving an instruction to shift the angle of view of the first image displayed on the display section from a user, wherein
the image processing section shifts the angle of view of the first image according to the instruction and cuts out, from the third image, an image corresponding to the angle of view of the first image after the shift, or shifts the third image according to the instruction and cuts out, from the third image after the shift, an image corresponding to same position and same size as the first image.

12. An image editing apparatus, comprising:
an image processing section generating a third image by combining data of a first image in a first pixel range and data of a second image in a second pixel range circumscribing the first image, the first image having an angle of view desired by a user and the data of the first image being generated by an imaging device having an image sensor which images a subject;
a display control section displaying the first image on a display section; and
an operating section receiving a magnification for zooming out the first image from a user, wherein
the image processing section reduces the third image according to the magnification and cuts out, from the third image being reduced, an image corresponding to a size of the first image, or expands the angle of view of the first image according to the magnification, cuts out, from the third image, an image corresponding to the angle of view of the first image being expanded, and reduces the image being cut out to the size of the first image.

13. (canceled)
